(19) United States
(12) Patent Application Publication
(10) Pub. No.: US 2025/0109780 A1
(43) Pub. Date: Apr. 3, 2025

(54) IMPROVED V-RIBBED BELT

(71) Applicant: Timken SMO LLC, North Canton, OH (US)

(72) Inventors: Daryl Lee HERMAN, Nixa, MO (US); Richard James WITT, Marionville, MO (US)

(21) Appl. No.: 18/833,106

(22) PCT Filed: Jan. 27, 2023
(86) PCT No.: PCT/US2023/061438

§ 371 Date: Jul. 25, 2024

Related U.S. Application Data
(60) Provisional application No. 63/311,238, filed on Feb. 17, 2022.
(60) Provisional application No. 63/304,339, filed on Jan. 28, 2022.

(51) Int. Cl. F16G 5/20; F16G 5/08

(52) U.S. Cl. CPC F16G 5/20; F16G 5/08

(57) ABSTRACT

The present invention provides V-ribbed transmission belt. The belt includes an upper portion with a top surface and a lower portion with a plurality of ribs spaced apart by V-shaped grooves. The upper portion may include a plurality of cords and a fabric cover on the top surface. The bottom surface of each of the ribs may comprise a fabric cover. The belt may have a smaller width to conventional V-ribbed belts while having less weight and providing greater power efficiency.

### CROSS-REFERENCE TO RELATED CASES

This application claims priority to, and any other benefit of, U.S. Provisional Patent Appl'n No. 63/304,339, filed Jan. 28, 2022, and U.S. Provisional Patent Appl′n No. 63/311,238, filed Feb. 17, 2022, the entire disclosures of which are incorporated by reference in their entireties as though set forth herein.

### FIELD

The present invention relates generally to a V-belt, and, more particularly, to a continuous V-ribbed power transmission belt.

### BACKGROUND

Transmission belts are widely known to translate rotational motion between axes. There are three different types of belts: conventional V-belts and drives (sets and joined), synchronous belts and drives, and V-ribbed belts and drives. Continuous transmission belts with V-shaped ribs, popularly referred to as V-belts, i.e., conventional V-belts, are widely used throughout many industries, such as agricultural and industrial applications. V-belts generally transmit power by friction and utilize a wedge principle to increase sidewall pressure and friction force.

Typical conventional V-belt drives may be wide and heavy to accommodate the ribs extending longitudinally around the inner circumference of the belt. Accordingly, conventional typical V-belt drives are too large or too heavy for many applications. For example, as the power of many applications increases, the available space to transmit the power is decreased, such as due to regulations, tooling, and the like. Further, conventional V-belt drives may be too heavy for certain applications, such as applications where extra weight impacts fuel efficiency.

Synchronous or timing belts may be used as an alternative to conventional V-belts, such as in applications with limited space availability. Synchronous belts transmit power by direct engagement of teeth with a sprocket. Synchronous belts may be more efficient and power dense. However, synchronous belts have disadvantages compared to conventional V-belts. For example, synchronous belts may be more difficult to install and are susceptible to issues resulting from misalignment, debris, and shock load. Additionally, synchronous belts are incompatible for use with clutch or a slip or as a drive fuse. Synchronous belts may also suffer from initial and long-term tensioning difficulties as well as bearing issues. Further, synchronous belts are often noisy in operation.

V-ribbed belts are a type of V-belt with multiple V-shaped ribs on the underside of the belt. V-ribbed belts may be smaller, lighter, longer lasting, more efficient, and capable of transmitting more power than conventional V-belts, and such belts have been used in the automotive industry. However, known V-ribbed belts are seldom used in other industries, such as the agricultural and industrial markets, due to power, alignment, and environmental factors and constraints within the industries.

Therefore, Applicant has recognized there is a desire for a V-ribbed belt that is smaller, lighter, more efficient, and capable of transmitting more power and that has a longer lifespan.

### SUMMARY

The present invention provides a V-ribbed power transmission belt.

In one embodiment, a continuous belt is provided. The continuous belt includes an upper portion with a top surface and a plurality of a cords. The continuous belt also has a lower portion with a plurality of ribs. The ribs define a plurality of grooves below the upper portion. Each rib includes a first wall and a second wall defining a peak for each groove. Each rib includes a bottom cover defining a bottom surface of the rib.

In one embodiment, a continuous belt is provided. The continuous belt includes an upper portion with a top surface and a plurality of cords. The continuous belt also includes a lower portion with a plurality of ribs. The ribs have a width and a height. The ribs define a plurality of grooves below the upper portion. Each rib includes a first wall and a second wall defining a peak for each groove. The belt has an aspect ratio between the width of the ribs and the height of the ribs. The aspect ratio is greater than 1.40.

In one embodiment, a method for manufacturing a V-ribbed belt is provided. The method includes the steps of placing a first fabric layer onto a drum, plying a first layer of rubber onto the drum, placing a plurality of cords on the plied rubber, plying a second layer of rubber into the drum, placing the plied rubber in a curing vessel, vulcanizing the ply, cutting the vulcanized ply into a square cut core, and machining grooves into the square cut core.

### BRIEF DESCRIPTION OF THE DRAWINGS

To further clarify various aspects of implementations of the present disclosure, a more particular description of the certain examples and implementations will be made by reference to various aspects of the appended drawings. These drawings depict only example implementations of the present disclosure and are therefore not to be considered limiting of the scope of the disclosure. Moreover, while the Figures can be drawn to scale for some examples, the Figures are not necessarily drawn to scale for all examples. Examples and other features and advantages of the present disclosure will be described and explained with additional specificity and detail through the use of the accompanying drawings in which:

FIG. 1 is a perspective view of an exemplary belt;

FIG. 2 is a partial perspective view of the belt of FIG. 1;

FIG. 3 is a cross-sectional view of the belt of FIG. 1;

FIG. 4 is a cross-sectional view of the belt of FIG. 1 with an exemplary top cover;

FIG. 5 is a cross-sectional view of the belt of FIG. 1 with an exemplary bottom cover;

FIG. 6 is a cross-sectional view of the belt of FIG. 1 with an exemplary cushioning portion;

FIG. 7 is a cross-sectional view of the belt of FIG. 1 with another exemplary cushioning portion;

FIG. 8 is a cross-sectional view of the belt of FIG. 1 with another exemplary cushioning portion;

FIG. 9 is a schematic sectional view of the belt of FIG. 1 according to an exemplary embodiment;

FIG. 10 is a flow diagram illustrating a method for manufacturing a V-ribbed belt;

FIG. 11 is a test setup according to a first example;

FIG. 12 is a test setup according to a second example; and

FIG. 13 is a test setup according to a third example.

### DETAILED DESCRIPTION

The present invention provides a continuous V-ribbed transmission belt.

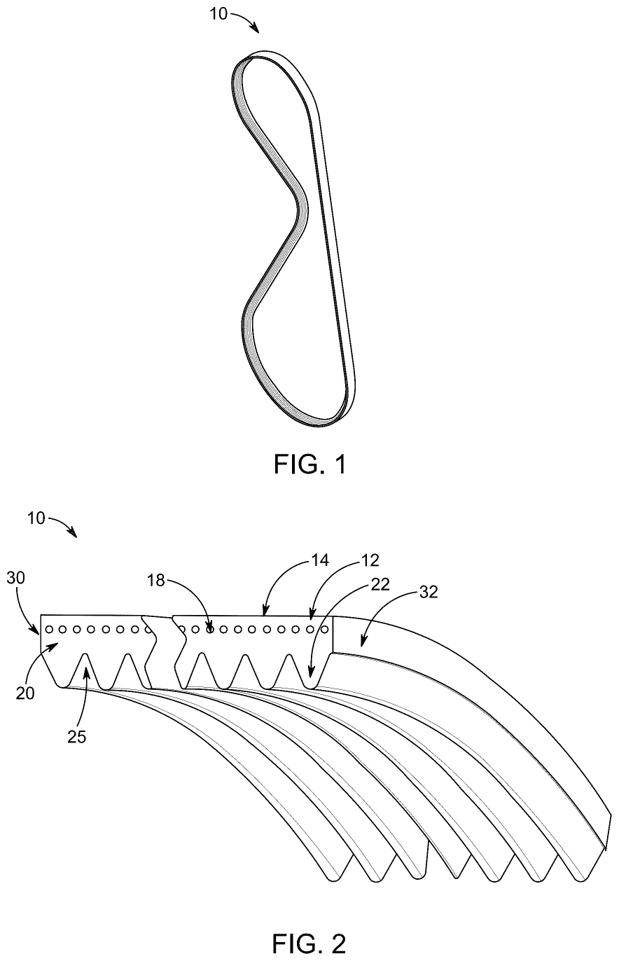

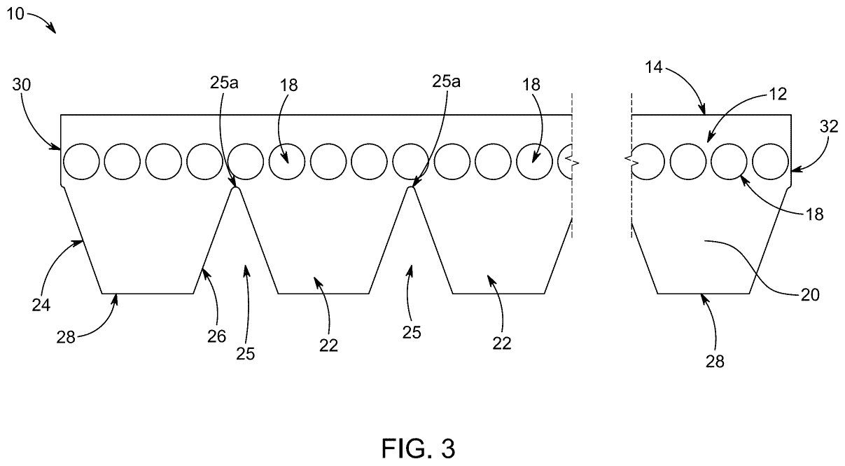

An exemplary implementation of a belt 10 is shown in FIGS. 1-9. The belt 10 may be a transmission belt configured to be disposed around one or more rotational elements, such as pulleys, shafts, or wheels, to translate rotational motion, such as in a drive system. The belt 10 may include an outer or upper portion 12 and an inner or lower portion 20 below or radially inward from the upper portion 12. The upper and lower portions 12, 20 may extend from a first side 30 to a second side 32 opposite the first side 30. The belt 10 may be in the form of a continuous loop such that the upper portion 12 is disposed radially outwardly from (e.g., above) the lower portion 20 and the lower portion 20 is disposed radially inwardly from (e.g., below) the upper portion 12.

The belt 10 may have an effective length (e.g., extending around a circumference of the belt) based upon the application of the belt 10, such as the drive system the belt 10 is to be used in. It is understood that that the effective length is the length of the belt 10 at a predefined location on one of the ribs. In exemplary embodiments, the belt 10 has an effective length of 2.1-2.3 meters, e.g., about 2277 mm or about 2217 mm.

While the belt 10 may be configured as a continuous loop, locations and positional relationships will be described in terms of a portion of the belt 10 shown in FIGS. 2-9 with the upper portion 12 disposed above the lower portion 20. Therefore, it will be understood that descriptions made to two-dimensional relative positions, such as above and below, also refer to radial positions of the continuous belt 10. For example, terms such as “above” and “below” refer to “radially outward from” and “radially inward from,” respectively, and terms such as “top” and “bottom” refer to “radially outermost” and “radially innermost.” Further, terms such as “upper” and “lower” refer to “radially outward portion” and “radially inward portion.”

The belt 10 may have a width extending between the first and second sides 30, 32. The first side 30, the second side 32, and/or the width of the belt 10 may be sized, shaped, and configured to couple with one or more rotational elements, such as pulleys, wheels, shafts, or the like. The belt 10 may be configured to translate rotational movement from one rotational element, such as a drive pulley, to one or more other rotational elements. For example, the first side 30, the second side 32, and/or the width of the belt 10 may be sized, shaped, and configured to be disposed in a channel or groove of one or more rotational elements when the belt 10 is at least partially disposed around the rotational elements such that the belt 10 rotates with the one or more rotational elements. In some embodiments, the belt 10 has a width between about 0.25 inches (e.g., about 6.35 mm) and about 10.0 inches (e.g., about 254 mm), such as between about 1.0 inch (e.g., about 2.54 mm) and about 5.0 inches (e.g., about 127 mm). In exemplary embodiments, the belt 10 has a width of about 1.11 inches (e.g., about 28.19 mm), about 1.48 inches (e.g., about 37.6 mm), about 1.85 inches (e.g., about 47 mm), about 2.22 inches (e.g., about 56.4 mm), or about 3.7 inches (e.g., about 94 mm). However, it will be understood that the width of the belt 10 may vary based on a number of factors, such as the number of ribs, the size of the ribs, the size of the grooves, and the like, as described below. For example, the belt 10 may have a width of 0.37 inches (e.g., about 9.4 mm) for each rib the belt 10 includes, as described below.

In the illustrated embodiments, the first and second sides 30, 32 are substantially planar. However, it will be understood that the first and second sides 30, 32 may have other shapes and configurations. For example, the first and/or second sides 30, 32 may be curved or otherwise rounded at the top and/or bottom ends, such as at the transitions or corners with the upper and lower portions 12, 20.

The lower portion 20 of the belt 10 may be configured to contact or otherwise engage with an outer circumference of (e.g., disposed around) one or more rotational elements such that the belt 10 and the respective rotational element(s) rotate together. For example, the lower portion 20 of the belt 10 may engage with an outer circumference of a drive rotational element such that rotation of the drive rotational element drives the rotation of the belt 10. The lower portion 20 of the belt 10 may also engage an outer circumference of (e.g., disposed around) one or more subsequent rotational elements such that rotation of the belt 10 drives the rotation of the subsequent rotational element(s). The lower portion 20 of the belt 10 may be sized, shaped, and configured to increase the rotational or power efficiency between the belt 10 and the rotational elements and to increase the durability and resiliency of the belt 10 during rotation, such as increasing the operational lifespan of the belt 10.

The upper portion 12 may include or define a top or outer surface 14 at the top of the upper portion 12 (e.g., facing radially outwardly from the remainder of the belt 10). The top surface 14 may be configured to provide resiliency and durability to the belt 10, such as to prevent the belt 10 from cracking or otherwise breaking during use. In the illustrated embodiment, the top surface 14 is substantially planar between the first and second sides 30, 32. However, it will be understood that the top surface 14 may have other shapes and configurations. For example, the top surface 14 may comprise texturing, detents, ribs, or the like, such as to increase the resiliency of the upper portion 12 of the belt 10.

The upper and lower portions 12, 20 may be sized, shaped, and configured to be flexible, durable, resilient, and manipulable, to increase the power efficiency of the belt 10, and to increase the operational lifespan of the belt 10. For example, the upper and lower portions 12, 20 may each comprise rubber. In some embodiments, the upper and lower portions 12, 20 comprise rubber polymers, such as polychloroprene rubber, ethylene propylene diene monomer (EPDM) rubber, or styrene-butadiene (SBR) rubber, carbon black, curatives, fibers, plasticizers, oils, coagents, or fibers, or any combinations thereof. In an exemplary embodiment, the upper and lower portions 12, 20 comprise a mixture of EPDM rubber, carbon black, curatives, fibers, plasticizers, oils, coagents, and fibers. One skilled in the art would understand to combine the above compositions and materials to achieve the characteristics of the belt 10 as described herein. In another exemplary embodiment, the upper and lower portions 12, 20 each comprise about 50-100 Parts per Hundred Rubber (PHR) of ethylene alpha-olefin, about 0-50 PHR of other conjugated diene polymer, about 0-50 PHR of discontinuous fiber or flock of natural or synthetic or inorganic composition (e.g., cotton, aramid, glass, polyester, nylon, polybenzoxazole (PBO), polyvinyl alcohol (PBA), polyethylene naphthalate (PEN), or the like), about 30-75 PHR carbon black, about 0-25 PHR of plasticizer (petroleum distillate or synthetic), about 2-10 PHR of curative (e.g., peroxide), about 0-25 PHR of coagent (Type I and/or Type II). The upper and lower portions 12, 20 may each also comprise antidegradants and process aids. If a cushion is used, exemplary cushions would have similar components, except exemplary cushions would not include fiber.

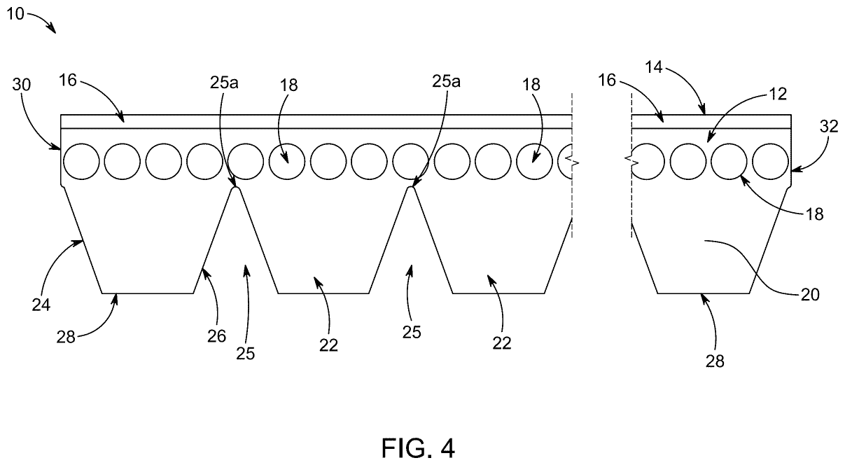

In some embodiments, as shown in FIG. 4, the upper portion 12 of the belt 10 includes a top cover 16 disposed on or near the top surface 14. The top cover 16 may be configured to prevent cracking, deformation, or wear of the top surface 14 and the upper portion 12 of the belt 10. In some embodiments, the top cover 16 is disposed in the upper portion 12 such that the cover defines the top surface 14 of the belt 10. In an exemplary embodiment, the top cover 16 comprises fabric, such as cotton, polyester, or aramid, or any combination thereof. In other embodiments, the top cover 16 comprises rubber, such as a more durable or resilient rubber, silicone, nitrile, vinyl, neoprene, or the like, or any combination thereof.

The lower portion 20 may include one or more ribs 22 extending downwardly from the upper portion 12. The ribs 22 may be configured to engage one or more rotational elements, such as when the belt 10 is disposed in a drive system. The belt 10 may include any suitable number of ribs 22. In exemplary embodiments, the belt 10 includes three ribs 22, four ribs 22, five ribs 22, six ribs 22, or ten ribs 22. In other embodiments, the belt 10 includes one rib 22, two ribs 22, seven to nine ribs 22, or eleven or more ribs 22. It will be understood that the belt 10 may have a number of ribs 22 depending on the width of the belt 10, the size of the ribs 22, the desired use of the belt 10 (e.g., operational speed, strain, etc.), or the like.

Each rib 22 may have a width extending along the width of the belt 10 between the first side 30 and the second side 32. In an exemplary embodiment, each rib 22 has a width between about 0.15 inches (e.g., about 3.8 mm) and about 0.5 inches (e.g., about 12.70 mm), such as 0.35-0.39 inches (e.g., about 8.89-9.91 mm), e.g., about 0.37 inches (e.g., about 9.4 mm). However, the ribs 22 may have other widths. For example, each rib 22 may have a width less than 0.37 inches or greater than 0.37 inches. Further, the width of one or more ribs 22 may be different from the widths of the other ribs 22.

Each rib 22 may include a first wall 24 extending downwardly from the upper portion 12, a second wall 26 opposite the first wall 24 and extending downwardly from the upper portion 12, and a channel or groove 25 between the first and second walls 24, 26 of adjacent ribs 22. The first and second walls 24, 26 may be substantially planar. The first wall 24 may be angled downwardly toward the second wall 26 such that a lower portion of the first wall 24 is closer to the second wall 26 than an upper portion of the first wall 24. The second wall 26 may be angled downwardly toward the first wall 24 such that a lower portion of the second wall 26 is closer to the first wall 24 than an upper portion of the second wall 26. The grooves 25 between the ribs 22 may be substantially V-shaped or triangular (e.g., in the cross-section view). Each rib 22 may be tapered or otherwise narrowed from an upper end near the upper portion 12 toward a lower end opposite the upper end based upon the angles of the first wall 24 and/or the second wall 26. The first and second walls 24, 26 may be angled substantially opposite each other such that each rib 22 is substantially symmetrical and such that each groove 25 is substantially symmetrical.

The first and second walls 24, 26 may form an angle at a point where the first and second walls 24, 26 would intersect, such as at a point below rib 22 if the first and second walls 24, 26 were extended. The angle may extend from the point where the first and second walls 24, 26 would intersect to the upper ends of the first and second walls 24, 26, such as extending along the first and second walls 24, 26. In some embodiments, the angle formed between the first and second walls 24, 26 is between about 20° and about 60°, such as between about 30° and about 50°. In an exemplary embodiment, the first and second walls 24, 26 about 40°. For example, the first wall 24 may be oriented at a 20° angle toward the first side 30 and the second wall 26 may be oriented at a 20° angle toward the second side 32. The grooves 25 may also form a downward facing angle substantially the same size as the angle between the first and second walls 24, 26.

While the first and second walls 24, 26 have been described as being substantially planar and angled toward each other such that each rib 22 is narrowed toward the lower end, it will be understood the ribs 22 may have other sizes, shapes, and configurations. For example, at least a portion of the first and second walls 24, 26 may be substantially vertical such that at least a portion of the rib 22 is substantially rectangular and/or at least a portion of the first wall 24 and/or second wall may be angled away from the other wall 24, 26 such that at least a portion of the rib 22 is wider. Further, one or more ribs 22 may have a different size, shape, and configuration than the other ribs 22.

Each rib 22 may include a bottom surface 28 at the bottom end of the rib 22 and facing generally away from the remainder of the belt 10 (e.g., radially inward). The bottom surface 28 may be configured to engage the outer circumference of one or more rotational elements. The bottom surface 28 may be sized, shaped, and configured to increase rotational efficiency between the belt 10 and the rotational element(s) and to increase the resiliency and durability of the belt 10. In the illustrated embodiment, the bottom surface 28 is generally planar and extends between the bottom ends of the first and second walls 24, 26. The bottom surface 28 may be substantially parallel to the top surface 14 of the belt 10. The bottom surface 28 may be textured or otherwise configured to have an increased coefficient of friction, such as to increase the power efficiency between the bottom surface 28 and the rotational elements. In some embodiments, the transitions or corners between the bottom surface 28 and the first and second walls 24, 26 are curved, rounded, or chamfered.

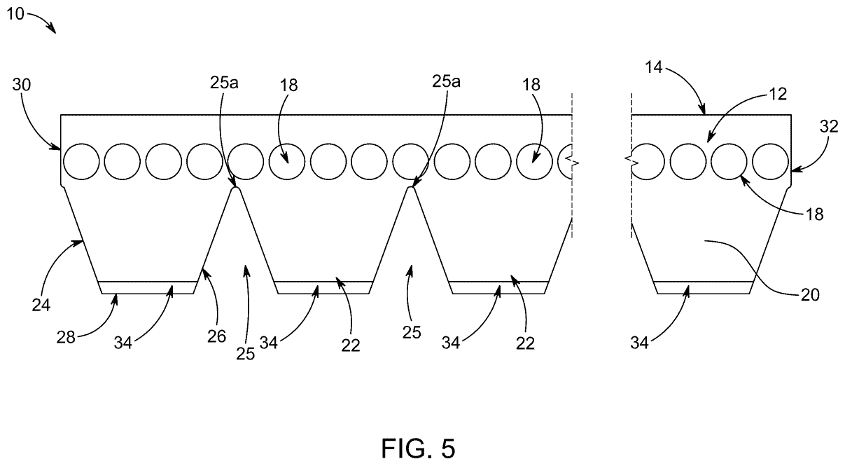

In some embodiments, as shown in FIG. 5, the bottom surface 28 of each rib 22 includes a bottom cover 34. The bottom cover 34 may be configured to prevent cracking, deformation, or wear of the ribs 22 and lower portion 20 of the belt 10, such as during use, to increase the power efficiency of the belt 10, and to increase the operational lifespan of the belt 10. In an exemplary embodiment, the bottom cover 34 comprises fabric, such as cotton, polyester, or aramid, or any combination thereof. In other embodiments, the bottom cover 34 comprises rubber, such as a more durable or resilient rubber, silicone, nitrile, vinyl, neoprene, or the like, or any combination thereof. In embodiments including the bottom cover 34, the bottom cover 34 may cover or define the bottom surfaces 28 of the ribs 22 and not the first and second walls 24, 26. For example, the first and second walls 24, 26 may comprise or be defined by rubber comprising the lower portion 20.

In the illustrated embodiments, the belt 10 is depicted as having either a top cover 16 (FIG. 4) or a bottom cover 34 (FIG. 5). However, it will be understood that the belt 10 may have other configurations. For example, the belt 10 may include a top cover 16 and a bottom cover 34.

The belt 10 may have a thickness or height extending between the top surface 14 and the bottom surfaces 28 of the ribs 22. The thickness of the belt 10 may be sized to increase the durability and resiliency of the belt 10 and such that the belt 10 may flex or bend, such as when the belt 10 is disposed around one or more rotational elements. The belt 10 may also have a thickness to increase the power efficiency of the belt 10 and to increase the operational lifespan of the belt 10. In an exemplary embodiment, the belt 10 has a thickness of about 0.38 inches (e.g., about 9.6 mm). However, the belt 10 may be sized, shaped, and configured to have different thicknesses. For example, the thickness of the belt 10 may be less than 0.380 inches or the thickness of the belt 10 may be greater than 0.380 inches. Further, the thickness of the belt 10 may be determined based upon the widths of the ribs 22. In an exemplary embodiment, the ratio of the thickness of the belt 10 to the width of the ribs 22 is about 1.03.

In the illustrated embodiment, the thickness of the belt 10 is substantially uniform. However, the thickness of the belt 10 may vary along the width of the belt 10 extending between the first and second sides 30, 32.

The bottom surface 28 of each rib 22 may have a width extending between the bottom ends of the first and second walls 24, 26. In an exemplary, the width of the bottom surface 28 of each rib 22 is about 0.205 inches (e.g., about 5.2 mm). However, it will be understood that the bottom surfaces 30 may have other sizes, shapes, and configurations. For example, the bottom surface 28 of each rib 22 may have a width less than 0.205 inches or greater than 0.205 inches. Further, the width of the bottom surface 28 of one or more ribs 22 may be different than the widths of other ribs 22. In still further embodiments, the bottom surface 28 of one or more ribs 22 may be formed as an apex or intersection of the respective first and second walls 24, 26.

Each groove 25 may have a width at the bottom end extending in the direction between the first and second walls 30, 32. In an exemplary embodiment, the width of the bottom of each groove 25 is about 0.165 inches (e.g., about 4.2 mm). However, it will be understood that the bottom of the grooves 25 may have other sizes, shapes, and configurations. For example, the width of the bottom of each groove 25 may be less than 0.165 inches or greater than 0.165 inches. Further, the width of the bottom of one or more grooves 25 may be different than the bottom widths of other grooves 25.

Each rib 22 may have a height or thickness extending from a top of the rib 22, such as the top of the first and second walls 24, 46, to the bottom surface 28. In an exemplary embodiment, each rib 22 has a height between about 0.15 inches (e.g., about 3.8 mm) and about 0.40 inches (e.g., about 10.2 mm), such as 0.21-0.23 inches (e.g., about 5.3-5.8 mm), e.g., about 0.226 inches (e.g., about 5.7 mm). However, the ribs 22 may have other heights. For example, each rib 22 may have a height less than 0.226 inches or greater than 0.226 inches. Further, the height of one or more ribs 22 may be different from the heights of the other ribs 22. In still further embodiments, the height of the ribs 22 may be determined in relation to the width of the ribs 22, the thickness of the belt 10, or other components of the belt 10, as described below.

The belt 10 may be configured such that the top end of the second wall 26 of each rib 22 is connected or adjacent to the top end of the first wall 26 of the adjacent rib 22 and vice versa such that the groove 25 forms a general V-shape. Each groove 25 may include or define an apex or peak 25a. The peak 25a may be formed by the connection or transition between the first and second walls 24, 26 of adjoining ribs 22. The peak 25a of the groove 25 may be the highest portion of the groove 25 and may be disposed equidistant between the adjoining ribs 22.

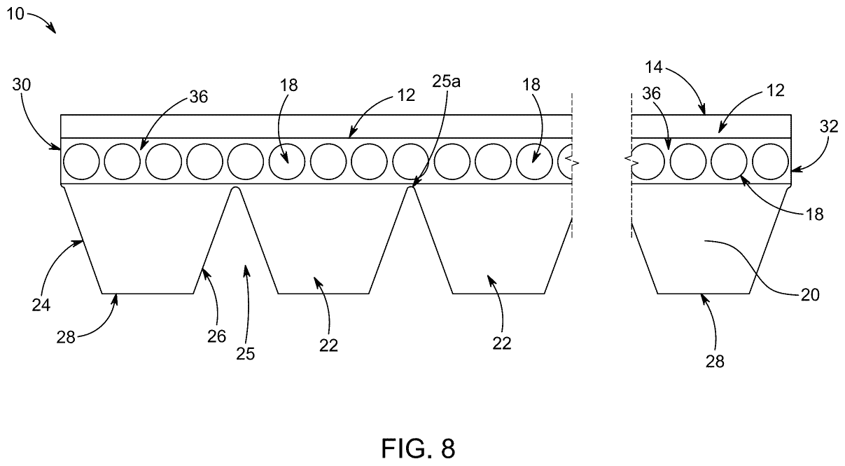

In an exemplary embodiment, the belt 10 is configured such that the peak 25a of the groove 25 is rounded. The peak 25a of the groove 25 may have a rounded radius between about 0.001 inches (e.g., about 0.025 mm) and about 0.030 inches (e.g., about 0.76 mm), such as a rounded radius between about 0.004 (e.g., about 0.10 mm) inches and about 0.015 inches (e.g., about 0.38 mm), such as a rounded radius of about 0.008 inches (e.g., about 0.20 mm). The peak 25a of the groove 25 may also be chamfered, filleted, or otherwise curved. In other embodiments, such as shown in FIG. 8, the top ends of the first and second walls 24, 26 may be substantially straight such that the peak 25a of the groove 25 is angled or pointed.

In an exemplary embodiment, the ribs 22 are integral with the remainder of the belt 10 and are formed by removing the V-shaped grooves 25 from a prefabricated square belt, such as a square cut core. The square core may a substantially rectangular belt with a continuous top surface and a continuous bottom surface. The bottom surface of the square cut core may be cut, machined, or grooved to form the grooves 25 and the first and second walls 24, 26 of the ribs 22. In such an embodiment, the first and second walls 24, 26 may be formed via machining, including cutting or grinding, and the bottom surface 28 of the ribs 22 may be formed without machining, such as formed during the manufacture of the square cut core.

The upper portion 12 may have a thickness extending from the top surface 14 to the top of the bottom portion 20, such as the tops of the ribs 22 and/or the peaks 25a of the grooves 25. In an exemplary embodiment, the thickness of the upper portion 12 is about 0.153 inches (e.g., about 3.9 mm). However, it will be understood that the upper portion 12 may have a different thickness. For example, the thickness of the upper portion 12 may be less than 0.153 inches or greater than 0.153 inches. In the illustrated embodiment, the thickness of the upper portion 12 is substantially uniform. However, the thickness of the upper portion 12 may vary along a length extending between the first and second sides 30, 32.

In some embodiments, the upper portion 12 of the belt 10 includes one or more cords 18 extending circumferentially around the belt 10. The cords 18 may be sized, shaped, positioned, and configured to provide structural resiliency, integrity, durability, and rigidity to the belt 10, such as to the top surface 14 and the upper portion 12 of the belt 10. The cords 18 may also increase the operational lifespan of the belt 10 and/or increase the power efficiency of the belt 10. In an exemplary embodiment, the cords 18 comprise aromatic polyamide (aramid) or Kevlar fibers. In other embodiments, the cords 18 comprise other heat-resistant and/or synthetic fibers, or combinations thereof.

In an exemplary embodiment, the cords 18 are disposed in the upper portion 12 such that a distance between a center point of each cord 18 and the top surface 14 is about 0.100 inches (e.g., about 2.54 mm) and a distance between the center point of each cord 18 and the peaks 25a of the grooves 25 is about 0.053 inches (e.g., about 1.35 mm). However, the cords 18 may be positioned in the belt 10 in other manners and configurations. For example, the distance between the center point of each cord 18 and the top surface 14 may be less than 0.100 inches or greater than 0.100 inches and/or the distance between the center point of each cord 18 and the peaks 25a of the grooves 25 may be less than 0.053 inches or greater than 0.053 inches. Further, one or more cords 18 may be disposed at a height different than the other cords 18.

The cords 18 may also be disposed in the belt 10 based upon a distance or height between the bottom of the cords 18 and the peaks 25a of the grooves 25. In some embodiments, the bottom of the cords 18 are substantially at the same height as the peaks 25a of the grooves 25. In other embodiments, the bottom of the cords 18 are above or below the peaks 25a of the grooves 25. For example, in some embodiments, the bottom of the cords 18 may be about 0.050 inches (e.g., about 1.3 mm) above the peaks 25a of the grooves 25 and, in other embodiments, the bottom of the cords 18 may be about 0.050 inches (e.g., about 9.4 mm) below the peaks 25a of the grooves 25.

In the illustrated embodiment, the cords 18 are disposed at evenly spaced intervals along the width of the belt 10. However, it will be understood that the cords 18 may be disposed in other configurations. For example, the cords 18 may be disposed in a continuous helix throughout the belt 10.

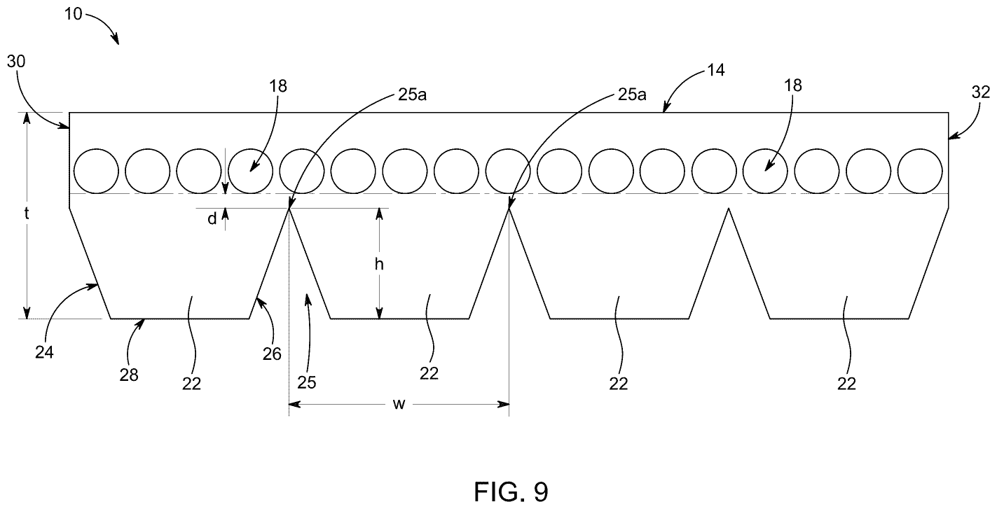

In the embodiment illustrated in FIG. 9, the belt 10 includes seventeen cords 18. However, it will be understood that the belt 10 may include a different number of cords 18. For example, the belt 10 may include sixteen or fewer cords 18 or eighteen or more cords 18, such as based on the size of the cords 18, the width of the belt 10, and the composition of the belt 10.

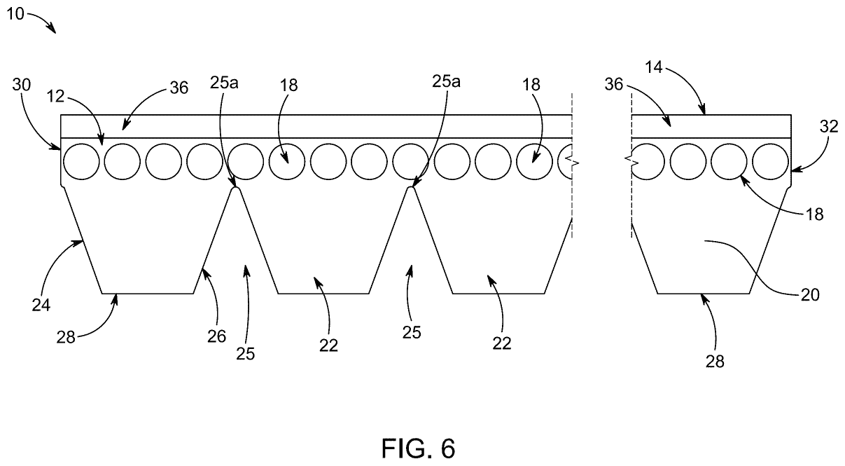

Referring now to FIGS. 6-8, the upper portion 12 of the belt 10 may include a cushion portion 36. The cushion portion 36 may be sized, shaped, and configured to cushion the upper portion 12 of the belt 10, such as to provide more flexibility and/or durability of the belt 10 during operation. The cushion portion 36 may also increase the power efficiency of the belt 10 and/or to increase the operational lifespan of the belt 10. The cushion portion 36 may comprise a different material than the remainder of the upper portion 12 and/or the lower portion 20, such as a softer or more durable material than the remainder of the upper portion 12 and/or the lower portion 20. In an exemplary embodiment, the cushion portion 36 comprises rubber. In some embodiments, the cushion portion 36 comprises a rubber polymer, such as polychloroprene rubber, EPDM rubber, or styrene-butadiene (SBR) rubber, or any combinations thereof. The cushion portion 36 may also comprise carbon black, a plasticizer, a curative, or a coagent, or any combinations thereof.

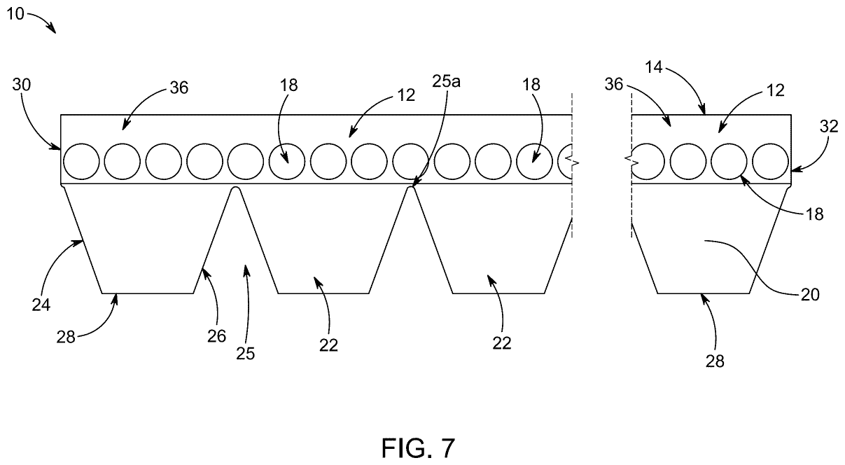

As shown in FIG. 6, the cushion portion 36 may be disposed above the cords 18. As shown in FIG. 7, the cushion portion 36 may extend below the cords 18 such that the cords 18 are disposed within the cushion portion 36. As shown in FIG. 8, the cushion portion 36 may extend from a height below the cords 18 to a height above the cords 18 and below the top surface 14, such that the cords 18 are disposed within the cushion portion 36. However, it will be understood that the cushion portion 36 has other sizes, shapes, and configurations. In some embodiments, the cushion portion 36 is thinner and disposed closer to the top surface 14 than shown in FIG. 6. In other embodiments, the cords 18 may be partially disposed in the cushion portion 36, such as with the cushion portion extending upwardly from a mid-point of the cords 18.

In the illustrated embodiments, the belt 10 includes a cushion portion 36 without top or bottom covers. However, it will be understood that the belt 10 may have other configurations. For example, the belt 10 may include a cushion portion 36 as well as a top cover 16 (FIG. 4) and/or a bottom cover 34 (FIG. 5).

Referring now to FIG. 9, the belt 10 may be sized, shaped, and configured to increase durability and resiliency, increase rotational efficiency, and decrease wear or breaking. The belt 10 may also be configured to increase the power efficiency of the belt 10 and to increase the operational lifespan of the belt 10. As shown in FIG. 9, the belt 10 may have a height or thickness t extending from the top surface 14 (e.g., radially outermost portion) of the belt 10 to the bottom surfaces 28 (e.g., radially inner most portions) of the ribs 22. Each rib 22 may have a height or thickness h extending between the bottom surface 28 of the rib 22 and the top of the rib 22, such as the peaks 25a of the grooves 25. The cords 18 may be disposed in the upper portion 12 such that the bottoms of the cords 18 are disposed a distance d above the peaks 25a of the grooves 25, such as above the top ends of the first and second walls 24, 26. The bottoms of the cords 18 may be disposed lower than the peaks 25a of the grooves 25 such that the distance d is negative. Each rib 22 may have a pitch or width w extending between the peaks 25a of adjacent grooves 25. In some embodiments, each rib 22 has a pitch w greater than or equal to about 4 mm, such as between about 4 mm and about 20 mm. In other embodiments, each rib 22 has a pitch w of about 0.37 inches (e.g., about 9.4 mm).

The belt 10 may have any aspect ratio defined as the ratio of the pitch or width w of the rib 22 to the thickness or height h of the rib 22. The aspect ratio of the belt 10 may be defined by the equation:

$$Aspect Ratio = \frac{w}{h}$$

The belt 10 may also have a groove cord pitch ratio defined as the ratio of the distance d of the bottom of the cords 18 above the tops of the grooves 25 to the width w of the ribs 22.

$$Groove Cord Pitch Ratio = \frac{d}{w}$$

The belt 10 may be sized, shaped, and configured based upon the aspect ratio. The belt 10 may be sized, shaped, and configured such that the aspect ratio of the belt is greater than or equal to 1.4, such as an aspect ratio between about 1.4 and about 2.5. In some embodiments, the aspect ratio of the belt 10 is between about 1.5 and about 1.6, such as about 1.54. In other embodiments, the belt 10 has an aspect ratio between about 1.6 and about 1.75.

The belt 10 may also be sized, shaped, and configured based upon the ratio of other measurements to the width of the ribs 22. In some embodiments, the ratio of the thickness of the rib plus 0.05 inches (e.g., bottom of the cords 0.05 inches higher; about 1.3 mm higher) to the width of the ribs 22 is about 1.27. In some embodiments, the ratio of the thickness of the rib minus 0.05 inches (e.g., bottom of the cords 0.050 inches lower; about 1.3 mm lower) to the width of the ribs 22 is about 1.94. In some embodiments, the ratio of the entire thickness of the belt 10 to the width of the ribs 22 is about 1.24.

The belt 10 may also be sized, shaped, and configured based upon the groove cord pitch ratio. The belt 10 may also be sized, shaped, and configured such that the groove cord pitch ratio is less than or equal to about 8.1%. In some embodiments, the groove cord pitch ratio is between about-8.1% and about 8.1%, such as between about-5.0% and about 8.1%. In some embodiments, the groove cord pitch ratio is between about 0.0% and about 8.1%. In some embodiments, the groove cord pitch ratio is between about-2.0% and about 2.0%. In still further embodiments, the groove cord pitch ratio is about 0.0%.

The belt 10 of the present disclosure may be configured to be thinner and narrower than conventional V-belts. For example, conventional 2HC and 3HC V-belts may have a thickness of about 16 mm and belts 10 of the present disclosure may have a thickness of about 9 mm. Conventional 2HC V-belts may have a width of about 51 mm and conventional 3HC V-belts may have a width of about 76 mm. In contrast, belts 10 of the present disclosure with three ribs 22 may have a width of about 1.11 inches (e.g. 28.2 mm), belts 10 of the present disclosure with four ribs 22 may have a width of about 1.48 inches (e.g., 37.6 mm), belts 10 of the present disclosure with five ribs 22 may have a width of about 1.85 inches (e.g., 47.0 mm), belts 10 of the present disclosure with six ribs 22 may have a width of about 2.22 inches (e.g., 56.4 mm) and belts 10 of the present disclosure with five ribs 22 may have a width of about 3.70 inches (e.g., 94.0 mm). Further, the belt 10 of the present disclosure may be configured to transmit more power, such as about twice the power, as conventional V-belts and to have a longer operational lifespan than conventional V-belts.

When the belt 10 is disposed around a rotational element, the belt 10 may have a power efficiency defined as the amount of rotational movement, which may be expressed as a percentage, transferred between the rotational element and the belt 10. The belt 10 may also be sized, shaped, and configured to increase the power efficiency of the belt 10. In some embodiments, the belt 10 may have a power efficiency between about 97% and about 99%, such as between about 98% and about 99%. In some embodiments, the belt 10 is configured to provide a high power efficiency for over 600 hours.

The belt 10 may be sized, shaped, and configured to have a longer operational lifespan. For example, in some embodiments, the belt 10 has an operational lifespan, on average, of over 490 hours. In some embodiments, the material dynamic compressive modulus E* of the ribs 22 in the with-grain direction at 121° C. is between about 48 MPa and about 75 MPa, such as about 48 MPa. In some embodiments, the RPA G* modulus at 175° C. of the belt 10 is greater than 5,000 kPa, such as between about 5,000 kPa and about 10,000 kPa.

The belt 10 may be sized, shaped, and configured to have an increase useful life. For example, in testing, it was found that, under similar operating conditions, the belt 10 of the present disclosure with three ribs 22 had an operational life over 490 hours compared to an operational life of about 75 hours for a conventional 2HC V-belt. Additionally, even in a misaligned position, the belt 10 had a longer operational life at higher power than prior art belts at lower powers.

Further, the belt 10 may be configured to be quieter in operation. In some embodiments, the belt 10 of the present disclosure may be operated at a noise between about 91 dBA and about 94 dBA. Comparatively, background noise may be between about 87 dBA and about 92 dBA and a similarly used synchronous belt may be operated at a noise between about 105 dBA and about 107 dBA. Moreover, the belt 10 may be less sensitive to misalignment and debris compared to a comparative synchronous belt.

FIG. 9 illustrates an exemplary methodology relating to manufacturing a belt with a plurality of ribs. While the methodology is shown as being a series of acts that are performed in a sequence, it is to be understood and appreciated that the methodology is not limited by the order of the sequence. For example, some acts can occur concurrently with another act. Further, in some instances, not all acts may be required to implement the methodology described herein.

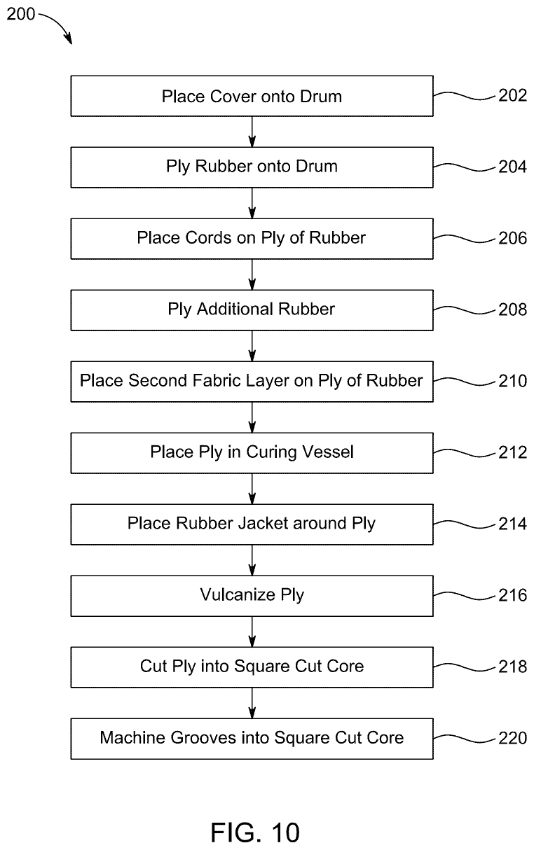

With reference to FIG. 10, a flow diagram is provided illustrating a methodology 200 for manufacturing a belt with a plurality of ribs. At step 202, a cover is placed or disposed onto a drum or cylinder. The drum or cylinder may be sized, shaped, and configured such that the drum is appropriately sized to yield a continuous belt of a desired size. In some embodiments, the cover is a layer of fabric. It will be understood that, in some embodiments, this step may be omitted, such as in embodiments where the belt 10 does not include a bottom cover 34 at the bottom of the ribs 22.

At step 204, a first layer of rubber is plied onto the drum, such as onto the cover (e.g., fabric layer). An appropriate amount of rubber may be plied onto the drum, such as based upon the location of the cords 18 in the belt 10. For example, an amount of rubber may be plied into the drum such that the first layer of rubber rises from the bottom of the drum (or top of the cover) to a height substantially equal to the height of the bottom of the cords 18 in the belt 10.

At step 206, one or more cords are placed or disposed on the plied rubber. The cords may be disposed in a continuous helix on top of the previously plied rubber. A number of cords may be placed onto the first layer of plied rubber according to the desired number of cords 18 in the belt 10.

At step 208, a second layer of rubber is plied into the drum, such as onto the first layer of rubber and the cords. An appropriate amount of rubber may be plied into the drum, such as based upon the location of the cords 18 in the upper portion 12 of the belt 10 and the height or thickness of the belt 10. For example, an amount of rubber may be plied into the drum such that the rubber rises above the cords 18 to the desired height of the top surface 14 of the belt 10 and such that the belt 10 has a desired height or thickness.

In some embodiments, the second layer of rubber may be a cushioning layer of rubber plied into the drum. In other embodiments, a layer of cushioning rubber may be plied onto the plied rubber before the second layer of rubber is plied. The cushioning rubber may be different than the rubber previously plied into the drum. The cushioning rubber may be plied from starting height to a top height corresponding to the cushion portion 36 described in FIGS. 6-8.

At step 210, a second cover is placed or disposed on the ply of rubber. The second cover may be a layer of fabric. It will be understood that, in some embodiments, this step may be omitted, such as in embodiments where the belt 10 does not include a top cover 16 at the top of the upper portion 12.

At step 212, the drum, including the ply-up (e.g., the result of steps 202 through 210), is placed or disposed in a curing vessel, such as a vulcanizer.

At step 214, a rubber jacket is placed or disposed around the ply-up. The rubber jacket may be placed around the completed ply-up to provide a seal between a floor of the curing vessel and a lid of the curing vessel. The rubber jacket may be disposed in the curing vessel to create an internal compartment and an external compartment within the curing vessel.

At step 216, the ply-up is vulcanized. The rubber may be vulcanized according to known steps of applying internal and external steam pressure.

At step 218, the vulcanized ply-up is cut into a square cut core. The cured ply-up may be removed from the curing vessel and the ply-up may be removed from the drum before cutting. The ply may be cut into appropriately sized segments as desired. The cuts may be perpendicular to the longitudinal axis of the sleeve/ply-up, such as based upon the desired width of the belt 10. A square cut core may result after the segments are cut and removed from the ply.

At step 220, grooves are machined into the square cut core. The grooves may be substantially V-shaped and may be cut, machined, or ground from the square cut core. For example, the machining and removal of the square cut core may result in the formation of the V-shaped grooves 25 as well as the first and second walls 24, 26, described above. In an exemplary embodiment, the bottom ends of the ribs (e.g., the bottom surfaces 28 of the ribs 22), i.e., the rib tips, are not machined or ground. As discussed herein, in exemplary embodiments, the rib tips (i.e., the inside circumference of the belt) have fabric, which means that the rib tips (i.e., the inside circumference of the belt) are not machined or ground after manufacturing. As shown herein, and the applications incorporated by reference, this can provide improved performance over belts having rib tips without fabric.

While the belt has been described as being manufactured from the bottom up, it will be understood that the belt may be manufactured in other ways. For example, the belt may be manufactured from the top down, such as starting with step 210, proceeding through steps 208 through 202 in reverse order, and then moving to step 212. If a fabric layer is added on the inside circumference, it is added in steps 204 or 208, depending on whether the belt is built upright or inverted. Exemplary belts are built inverted, so belt fabric is added in step 208.

### Example 1

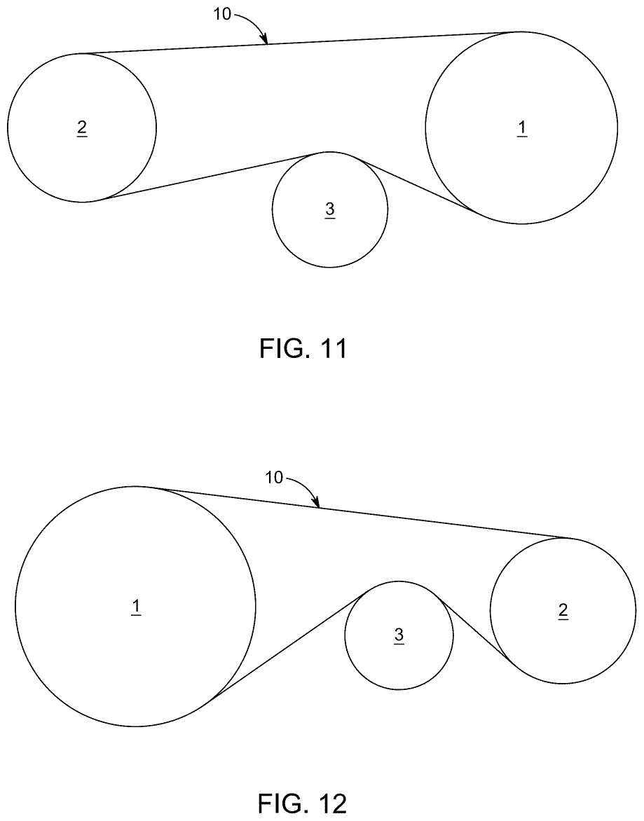

Referring now to FIG. 11, belts 10 of the present disclosure were tested to determine the operational lifespan of the belt 10 compared to conventional 2HC V-belts (e.g., two conventional V-ribs) under similar operating conditions. The belt 10 was configured with three ribs 22 and an effective length of about 2662 mm. The 2HC belt had an effective length of about 2700 mm. The belts were disposed around a drive pulley 1 and a second pulley 2 and was tensioned with an idler 3.

For the conventional 2HC belt, the drive pulley 1 had a diameter of about 365.8 mm, the second pulley 2 had a diameter of about 276.0 mm, and the idler 3 had a diameter of about 203.2 mm. For the belt 10 of the present disclosure, the drive pulley 1 had a diameter of about 355.6 mm, the second pulley 2 had a diameter of about 274.3 mm, and the idler 3 had a diameter of about 203.2 mm. The belts were driven by the drive pulley 1 such that the second pulley rotated at about 2070 RPM at about 140 KW, with a force of about 6760 applied to a horizontal face of the second pulley 2 (e.g., drive pulley at 1590 RPM for conventional 2HC belt and drive pulley at 1620 RPM for belt 10 of present disclosure). Both belts were tested with a misalignment of about 0.4°.

The belts were monitored over time. The temperatures of the belts were recorded as well as the operational life of the belt, defined as the amount of time until failure. Failures were defined as the top lifting off the cord, slipping out, and chunking out. The results of the testing were as follows.

| | | | | Running |
|---|---|---|---|---|
| | | | Max Temp. | Temp. |
| Belt Type | Belt No. | Life (Hrs.) | (° C.) | (° C.) |
| Conventional | 1 | 76 | 116 | 93 |
| 2HC V-belt | 2 | 16 | 122 | 104 |
| | 3 | 192 | 124 | 93 |
| | 4 | 16 | 127 | 96 |
| Belt 10 with | 1 | 676 | 73 | 67 |
| three ribs 22 | 2 | >311 | 75 | 68 |
| | 3 | 484 | 77 | 67 |

The second tested belt 10 of the present disclosure was monitored. It experienced a first crack at about 149 hours and experienced no change thereafter until 311 hours, when the test was discontinued. Accordingly, the average operational life of the conventional 2HC belt was about 75 hours and the average operational life of the belt 10 of the present disclosure was over 490 hours.

### Example 2

Referring now to FIG. 12, belts 10 of the present disclosure were tested to determine the operational lifespan of the belt 10 based upon the aspect ratio and the groove cord pitch ratio of the belt 10. The belt 10 was configured with ten ribs 22 and an effective length of about 2217 mm. The belt 10 was disposed around a drive pulley 1 and a second pulley 2 and was tensioned with an idler 3. The drive pulley 1 had a diameter of about 213 mm, the second pulley 2 had a diameter of about 315 mm, and the idler 3 had a diameter of about 152 mm. The belt 10 was driven by the drive pulley 1 such that the second pulley 2 rotated at a rate of about 1792 RPM at about 179 kW, with a force of about 10,900 N applied to a horizontal face of the second pulley 2. The belt 10 was run and monitored. The number of cracks were monitored over time and the time to failure was also monitored. Times were logged for the first crack in the belt 10, the tenth crack in the belt 10, and the failure of the belt 10.

The aspect ratio testing was performed on three belts 10 with different aspect ratios. The first belt 10 had an aspect ratio of 1.23, the second belt 10 had an aspect ratio of 1.60, and the third belt 10 had an aspect ratio of 1.75. The results of the testing based upon variations of aspect ratio were as follows.

| | Rib Aspect Ratio | | |
|---|---|---|---|
| Criteria | 1.23 | 1.60 | 1.75 |
| Hours to 1^{st} Crack | <97 | 202 | 175 |
| Hours to 10^{th} Crack | — | 264 | 509 |
| Hours to Failure | 97 | 379 | 622 |

The groove cord pitch ratio testing was performed on four belts based upon the groove cord pitch ratio and the aspect ratio. The first belt 10 had an aspect ratio of 1.60 and a groove cord pitch ratio of 8.1%, the second belt 10 had an aspect ratio of 1.60 and a groove cord pitch ratio of 0.0%, the third belt 10 had an aspect ratio of 1.75 and a groove cord pitch ratio of 8.1%, and the fourth belt 10 had an aspect ratio of 1.75 and a groove cord pitch ratio of 0.0%. The results of the testing based upon variations of groove cord pitch ratio, including variations of aspect ratio, were as follows.

| | Groove Cord Pitch Ratio | | | |
|---|---|---|---|---|
| | Aspect Ratio = 1.60 | | Aspect Ratio = 1.75 | |
| Criteria | 8.1% | 0.0% | 8.1% | 0.0% |
| Hours to 1^{st} Crack | 202 | 235 | 175 | 580 |
| Hours to 10^{th} Crack | 264 | 373 | 509 | — |
| Hours to Failure | 379 | 504 | 622 | 614 |

### Example 3

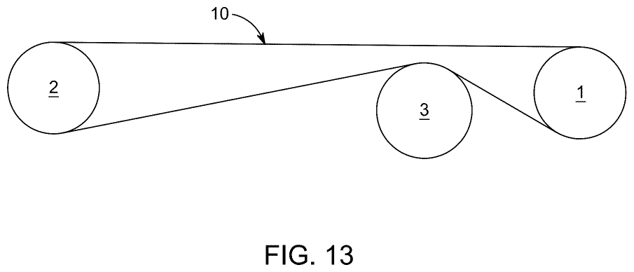

Referring now to FIG. 13, a belt 10 of the present disclosure was tested to determine its Young's modulus (E*) and shear modulus (G*). The belt 10 was configured with four ribs 22 and had an effective length of about 2277 mm. The belt 10 was disposed around a drive pulley 1 and a second pulley 2 and was tensioned with an idler 3. The drive pulley 1 had a diameter of about 151 mm, the second pulley 2 had a diameter of about 151 mm, and the idler 3 had a diameter of about 152 mm. The belt 10 was driven by the drive pulley 1 such that the second pulley 2 rotated at a rate of about 2400 RPM at about 57 kW, with a force of about 8000 N applied to a horizontal face of the second pulley 2. The belt 10 was run to determine the rib material dynamic compressive modulus E* in the with-grain direction at 121° C. and the RPA G* modulus at 175° C.

The belt 10 was tested with a first composition (Material 1) and a second composition (Material 2). The two compositions are shown in the table below, in which the first two lines are the “rubber” polymers and will add up to 100 and the remaining lines are additional components added to the rubber polymers PHR (parts per hundred rubber). Looking, for example, at the Material 2 column, for every 100 parts (lbs, kg, etc.) of rubber (upper two lines combined), there are 25-50 parts of fiber, 45-75 parts of carbon black, 5-15 parts of plasticizer, etc.

| Formulation | Material 1 (PHR) | Material 2 (PHR) |
|---|---|---|
| Ethylene alpha-olefin | 50-100 | 70-95 |
| Other conjugated diene polymer | 0-50 | 5-30 |
| Discontinuous fiber | 0-50 | 25-50 |
| or flock of natural, | | |
| synthetic, or inorganic composition | | |
| Carbon black | 30-75 | 45-75 |
| Plasticizer | 0-25 | 5-15 |
| Curative | 2-10 | 2-5 |
| Coagent | 0-25 | 5-20 |

Two samples of each composition were tested. The results of the testing were as follows.

| | |
|---|---|
| Modulus | Hours to Failure |

| Material | E* (MPa) | G* (MPa) | Sample 1 | Sample 2 |
|---|---|---|---|---|
| 1 | 39.9 | 2.2 | 60 | 54 |
| 2 | 63.7 | 6.0 | 170 | 156 |

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

While various inventive aspects, concepts and features may be described and illustrated herein in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present disclosure. Still further, while various alternative embodiments as to the various inventive aspects, concepts and features—such as alternative materials, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present disclosure even if such embodiments are not expressly disclosed herein. Additionally, even though some inventive aspects, concepts, or features may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, descriptions of exemplary methods or processes are not limited to inclusion of all steps as being required in all cases, nor is the order that the steps are presented to be construed as required or necessary unless expressly so stated or the context dictates otherwise.

One of ordinary skill in the art will now appreciate that the present invention provides continuous transmission belt with a plurality of ribs. Although the present invention has been shown and described with reference to particular embodiments, equivalent alterations and modifications will occur to those skill in the art upon reading and understanding this specification. The present invention includes all such equivalent alterations and modifications and is limited only by the scope of the following claims in light of their full scope of equivalents.

1. A continuous belt comprising:
an upper portion including a top surface and a plurality of cords; and
a lower portion comprising a plurality of ribs, the ribs having a width and defining a plurality of grooves below the upper portion;
wherein each rib includes a first wall and a second wall defining a peak for each groove;
wherein the width of the ribs is between 0.15 inches (e.g., about 3.8 mm) and 0.50 inches (e.g., about 12.7 mm);
wherein each rib includes a bottom cover defining a bottom surface of the rib; and
wherein the belt has a dynamic compressive modulus E* in the with-grain direction at 121° C. greater than 48 MPa.

2. The continuous belt according to claim 1, wherein the bottom cover comprises fabric.

3. The continuous belt according to claim 1, further comprising a top cover defining the top surface.

4. The continuous belt according to claim 3, wherein the top cover comprises fabric.

5. The continuous belt according to claim 1, wherein the peak of each groove is rounded.

6. The continuous belt according to claim 1, wherein the bottom cover does not cover the first and second walls.

7. The continuous belt according to claim 1, wherein the belt has an RPA G* modulus at 175° C. greater than 5,000 kPa.

8. The continuous belt according to claim 1, wherein the upper portion includes a cushion portion comprising a material different than a material of the lower portion.

9. A continuous belt comprising:
an upper portion including a top surface and a plurality of cords; and
a lower portion comprising a plurality of ribs, the ribs having a width and a height and defining a plurality of grooves below the upper portion;
wherein the width of the ribs is between 0.15 inches (e.g., about 3.8 mm) and 0.50 inches (e.g., about 12.7 mm);
wherein the belt has a groove cord pitch ratio between a height of a bottom of the cords above the peaks of the grooves and the width of the ribs; and
wherein the groove cord pitch ratio is less than 8%.

10. The continuous belt according to claim 9, wherein each rib includes a first wall and a second wall defining a peak for each groove; and
wherein the belt has an aspect ratio between the width of the ribs and the height of the ribs, the aspect ratio being greater than 1.40.

11. The continuous belt according to claim 10, wherein the aspect ratio is between 1.60 and 1.75.

12. The continuous belt according to claim 9, wherein the width of each rib is greater than 4 mm.

13. The continuous belt according to claim 9, wherein the width of the ribs is between 0 0.36-0.38 inches (e.g., about 9.1-9.6 mm), e.g., about 0.37 inches (e.g., about 9.4 mm).

14. The continuous belt according to claim 9, wherein the height of the ribs is between 0.15 inches and 0.40 inches (e.g., about 10.2 mm), such as 0.22-0.23 inches (e.g., about 5.6-5.8 mm), e.g., about 0.227 inches (e.g., about 5.77 mm).

15. The continuous belt according to claim 9, wherein each rib includes a bottom cover defining the bottom surface.

16. A method for manufacturing a V-ribbed belt, the method comprising the steps of:
placing a first fabric layer onto a drum;
plying a first layer of rubber onto the drum;
placing a plurality of cords on the plied rubber;
plying a second layer of rubber into the drum;
placing the plied rubber in a curing vessel;
vulcanizing the ply;
cutting the vulcanized ply into a square cut core; and
machining grooves into the square cut core.

17. The method according to claim 16, further comprising the step of placing a second fabric layer onto the plied rubber.

18. The method according to claim 16, wherein the second layer of rubber comprises a cushioning rubber.

19. The method according to claim 16, further comprising the step of disposing a rubber jack around the ply before vulcanizing the ply.

20. The method according to claim 16, wherein the cords are disposed in a continuous helix.

21. (canceled)
